(19) United States
(12) Patent Application Publication
(10) Pub. No.: US 2007/0192106 A1
(43) Pub. Date: Aug. 16, 2007

(54) System and method for creating and using personality models for user interactions in a social network

(75) Inventor: Ran Zilca, Briarcliff Manor, NY (US)

Correspondence Address: KEUSEY, TUTUNJIAN & BITETTO, P.C., 20 CROSSWAYS PARK NORTH, SUITE 210, WOODBURY, NY, 11797, US

(73) Assignee: SIGNAL MATCH INC.

(21) Appl. No.: 11/581,051

(22) Filed: Oct. 13, 2006

Related U.S. Application Data
(60) Provisional application No. 60/772,638, filed on Feb. 13, 2006.
(60) Provisional application No. 60/795,238, filed on Apr. 25, 2006.

(51) Int. Cl. G10L 21/00

(52) U.S. Cl. 704/270

(57) ABSTRACT

A social computing system and method includes a model creator configured to create an initial model of a user and a model enhancement module configured to analyze and record interactions of the user with other users in a social network to update and adjust the initial model to provide an enhanced model for the user. An interaction module is configured to permit interaction between user by employing one of the initial model and the enhanced model.

### RELATED APPLICATION DATA

This application claims the benefit of U.S. Provisional Application Ser. Nos. 60/772,638, filed Feb. 13, 2006 and 60/795,238, filed Apr. 25, 2006, which are incorporated by reference herein in their entirety.

### BACKGROUND

1. Technical Field

The present invention relates to human computer interaction, and more particularly to social computing systems and methods that employ models for interaction between users and improve the models based upon interaction history and information gathered from a plurality of sources.

2. Description of the Related Art

Social Computing (SC) systems provide different ways for users to discover other users and then interact and communicate with the other users based on the discovered information. In many systems, each user has a profile that includes various different pieces of information about the user. The information in each user profile may include different user attributes which may be manually entered, automatically fed from an external system, or both.

Examples of user profile attributes include: residential address, list of favorite songs, current and previous employers, personal interests and hobbies, favorite actors and artists, and art and music genre preferences, etc.

In conventional SC systems, the discovery of new users is accomplished either by searching for familiar people by name, or by searching the profiles of unfamiliar users for certain desired attributes. For example, users may be searched by location of residence, personal and professional interests, employers, income, etc. Once users are found, user interaction may be in the form of sending and receiving live or offline text messages, audio and video between users, and/or by providing contact details that are external to the system such as a phone number or email address.

User profiles currently do not reflect the personality of users in a meaningful way, and therefore user discovery and interaction is typically performed with no knowledge of the user personality.

### SUMMARY

A social computing system and method includes a model creator configured to create an initial model of a user and a model enhancement module configured to analyze and record interactions of the user with other users in a social network to update and adjust the initial model to provide an enhanced model for the user. An interaction module is configured to permit interaction between user by employing one of the initial model and the enhanced model.

A method for social computing in accordance with present principles includes creating an initial model of a user, updating and adjusting the initial model to provide an enhanced model for the user by analyzing and recording interactions of the user with other users in a social network, and identifying other users with similar characteristics based on one of an initial model and an enhanced model of the other users pursuant to an inquiry of the user.

A social computing system includes a model creator configured to create an initial model of a user, and a model enhancement module configured to analyze and record interactions of the user with other users in a social network to update and adjust the initial model to provide an enhanced model for the user. An interaction module is configured to permit searches by the user to search one of an initial model and an enhanced model of other users wherein the interaction module calculates a personality match score between models of users in the social network indicating closeness based on one or more criteria. A visualization graph is generated by the interaction module based on closeness criteria between the user models.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for employing personality models in profiles for a social computing system;

FIG. 2 is a block/flow diagram showing the creation of a personality model in accordance with one embodiment;

FIG. 3 is a block/flow diagram showing the generation of a personality match score;

FIG. 4 a diagram showing relationships between personality models and personality types;

FIG. 5 is a visualization graph displaying a visualization method in accordance with an illustrative embodiment;

FIG. 6 is a visualization graph showing personality traits of a plurality of users clustered and graphed to permit selections by other users;

FIG. 7 is a block/flow diagram showing a system/method for implementing interaction between users in a social computing system; and

FIG. 8 is a block/flow diagram showing an illustrative system/method for interacting between users in a social computing system.

### DETAILED DESCRIPTION OF PREFERRED EMBODIMENTS

Embodiments in accordance with present principles employ a model or models of user personality that is/are stored in the user profile. This permits users to be searched by personality, and have their personalities matched and grouped, and provide a visual network representation of users by personality similarity.

In one illustrative embodiment, a system/method includes creating a personality model (PM) or profile for a user and matching the personality models of two users and obtaining a personality match score (PMS). Users are then grouped into personality groups called personality types (PT). PT's are groupings of PM's. A PM may belong to one or more PT.

Using a combination of the above elements, a variety of functions may be achieved by a social computing (SC) system. Users may be discovered based on their PT or by matching their PM's with reference PM's of other users (using the PMS). Users that know each other can check their personality match using the PMS. User interaction may be adapted to the user's PT and/or PM. The information on users' PT, PM, and their PMS with other users may be visualized so that the space of users may be browsed by personality.

The above functions may be performed solely based on the personality data, or in combination with other types of information that exists in the profile. For example, a visualization showing the people that are closest in personality to a user may be filtered to show only females that live within 20 miles of the user and share the same musical taste. In addition, functions that are not directly related to finding users and interacting with them may be obtained based on the elements of personality modeling, matching, and grouping to personality types. For example, users may receive content or content-recommendations based on their PM or PT's. Examples of content may include music, video, images, news reports, products or services for purchase, advertisements, and ring tones.

In one embodiment, the content or content-recommendations are obtained by analyzing the statistical relationship between certain PT's or PM groups and certain content, e.g., recommending content that is more likely to be consumed by users of similar personality.

It is to be understood that the present embodiments are described in terms of a social computer systems; however, the present invention is much broader and may include any digital system, which is capable of employing personality traits and provides comparison using visual representations of such.

It should also be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), non-volatile storage, etc.

Other hardware, conventional and/or custom, may also be included. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc. Embodiments can take the form of a computer program product accessible from a computer-usable or computer-readable medium providing program code for use by or in connection with a computer or any instruction execution system. The computer-usable or computer readable medium can includes electronic, magnetic, optical, electromagnetic, infrared, or semiconductor system (or apparatus or device) or a propagation medium. Examples of the medium may include a semiconductor or solid state memory, magnetic tape, a removable computer diskette, a random access memory (RAM), a read-only memory (ROM), a rigid magnetic disk and an optical disk.

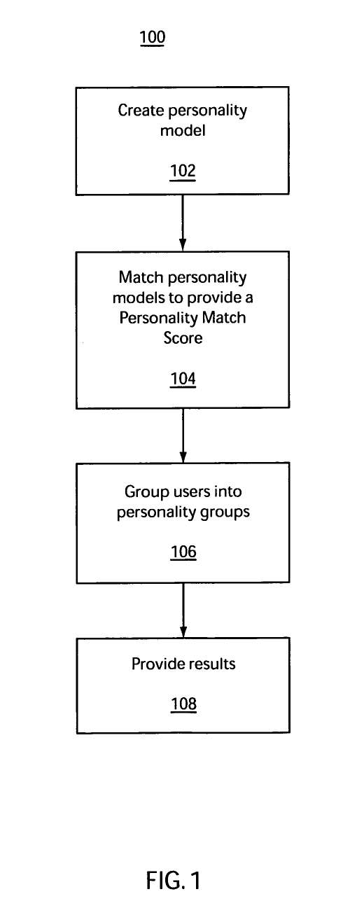

Referring now to the drawings in which like numerals represent the same or similar elements and initially to FIG. 1, a block/flow diagram shows an overall system/method for providing social computing (SC) services in accordance with one illustrative embodiment. In block 102, a personality model (PM) is created. A PM may be created using a questionnaire or by recording and analyzing the user interaction with other users within a SC system 100. An initial model may be created by filling out a questionnaire, and then the initial model may be updated by analyzing the user's interaction patterns. In one alternative, the PM model is created using corroborative information, such as input from other users to verify, construct or augment the user's PM (e.g. a questionnaire for people who know the user).

Although a personality model PM is illustratively described other types of models may be included or used instead of the PM. For example, in addition to personality, additional measures of users may include: social attitude (which may describe a person's values and beliefs, such as, conservativeness, religious faith, patriotism, etc.); vocational interests (which may described general interests related to work, tendency to work with hands (e.g. crafts), tendency to be influential, etc.); avocational interests (e.g., interests related to non-work issues, like music, theatre, TV shows, etc.; and others.

Weightings may be associated with a plurality of information based on multiple factors, such as degree of corroboration, reliability of the source of information, relationship of third parties supplying the information about a user. The weights may be used, e.g., averaged, in constructing an average profile for the user.

The resulting PM may comply with known personality parameter sets such as a Five Factor Model (FFM), a Big Five model, and a seven factor model, known in the art. A user's PM may be coupled with one or more World Models (WM) that describe a general distribution of personality parameters in a general population, or in a population that is the most relevant for the user (for example, users of the same gender).

The user PM may be trained “from scratch” or adapted from a WM. In one embodiment, the PM is a Gaussian model describing a multivariate distribution of personality parameters in terms of a mean vector and standard deviation vector, and the WM includes the same parameters as measured on a reference population.

Interactions between users may be employed to create personality models. When users interact with each other, their behavior will disclose some of their personality traits (and possibly social attitude and interests). For example, more extraverted users may take more time to write responses than their partner in an IM conversation. Users with higher intellect may spend more time searching for information, etc. Therefore, it is possible to predict personality and social traits, as well as interests from observing the users' behavior, both when interacting with other users directly, and indirectly (e.g. posting a blog as a one sided communication, but expecting comments on the postings).

Once this information is collected, the system can modify the model (adaptive model) based on user behavior. The variables that constitute the user model can be updated over time when new information is available. This may be done directly by prompting the user to enter more data, or indirectly by observing user behavior. Since the models are statistical, their variables represent statistical measures such as means and variances. These variables can therefore be easily updated to reflect the new data using techniques for adapting statistical models such as Bayesian adaptation.

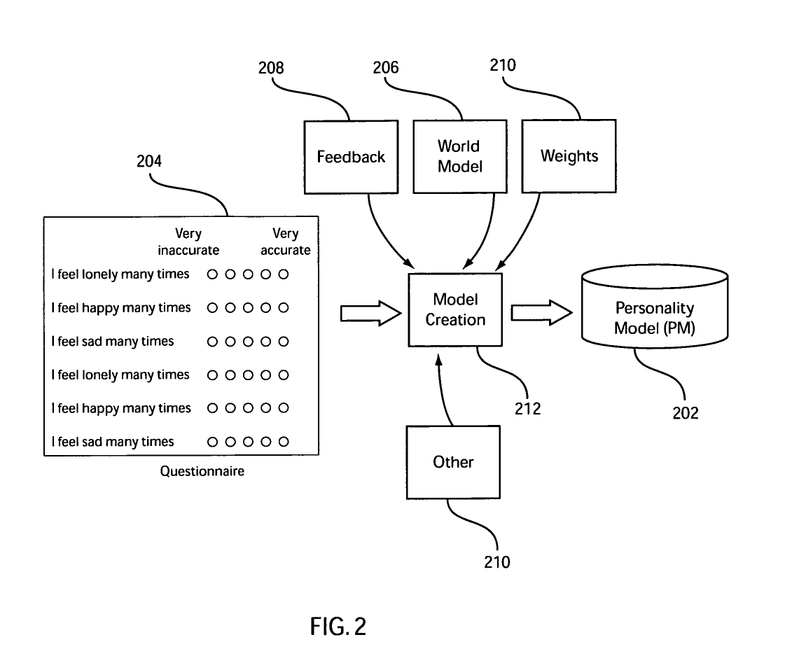

Referring to FIG. 2, a process for creating a PM 202 from scratch is illustratively shown. Input sources may include one or more of a questionnaire 204, a world model 206, feedback from other users 208, and other information sources 210. Weightings 210 may be applied to any and all of the sources of information to change the importance of the data based on numerous factors.

Raw results of the questionnaire 204 (or other information sources) are passed to a model creation module or method 212 that converts the raw answers to the PM 202. The conversion may be achieved by a scoring method where a response to each question is converted to continuous numbers, including decimal numbers.

In block 104 of FIG. 1, the personality models/profiles of two or more users are matched and a Personality Similarity/Match Score (PMS) is obtained. The PMS is a measure of similarity between two (or more) PM's. It can represent either a straightforward similarity between the personalities of two people, or measure how well two personalities match for a specific desired type of relationship.

For example, if PM's are described by Gaussian models, a PMS may be computed as the Kullback-Leibler divergence between the two Gaussian models, indicating a straightforward similarity match. Another example where the PMS does not directly indicate similarity and is pointed to a specific type of relationship is calculating a PMS between two personalities for the purpose of becoming spouses, or for the purpose of one reporting to the other at work.

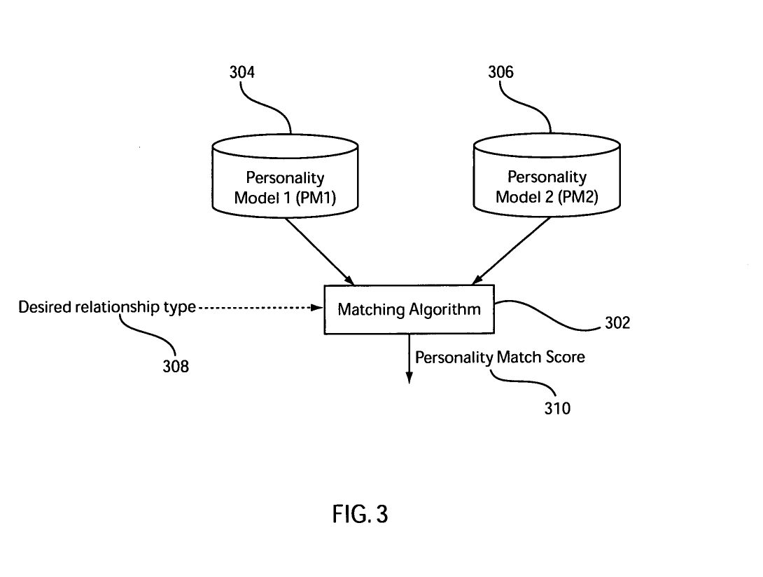

Referring to FIG. 3, an illustrative method for generating a PMS between two models is shown. A matching algorithm or method 302 is utilized to generate a score 310 based on input PM's 304 and 306 and optionally a desired relationship 308 between the two people that the PM's 304 and 306 represent. For example, the matching algorithm 302 may be used differently, or a different matching algorithm altogether will be used, if the two users need to work together as opposed to going together on a trip. Other relationships between the two people may also be used and may be defined by one of the people, other user(s), or selected from a predefined list or menu.

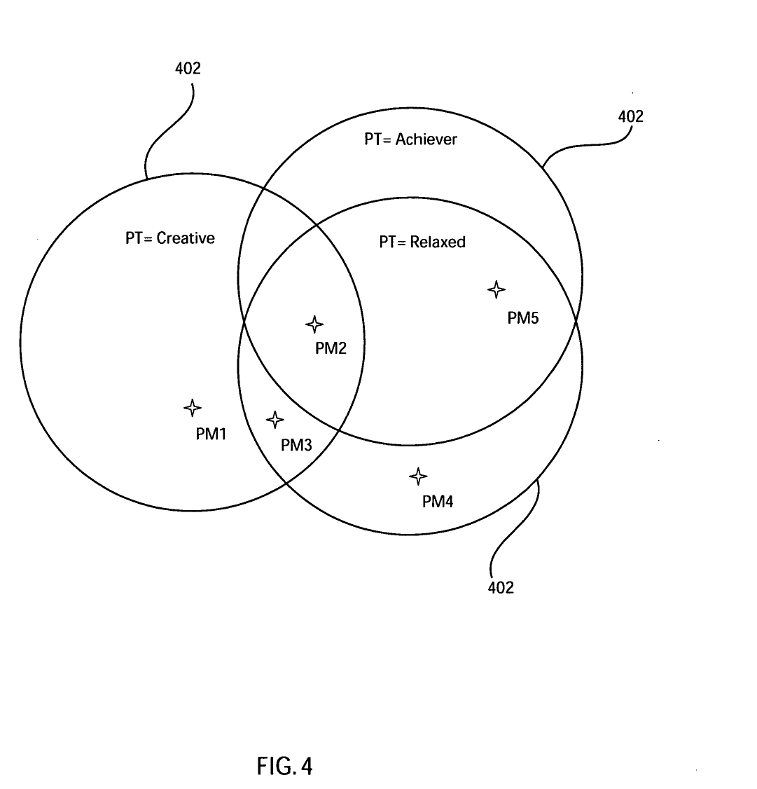

Referring again to FIG. 1, in block 106, users are grouped into personality groups called Personality Types (PT). PT's are supersets of PM's. Every PM can belong to one or more PT. Relationships between a set of PM's and a set of PT's are illustratively shown in FIG. 4.

Referring to FIG. 4, a plurality of PT's 402 includes a creative PT, and achiever PT and a relaxed PT. Each PT includes one or more PM's. Some PM's belong to multiple PT's. For example, PM1 is in the creative PT, PM2 in is the creative, achiever and relaxed PT's, PM3 is in creative and relaxed PT's, PM4 is in the relaxed PT, and PM5 is in achiever and relaxed PT's.

The different PT's that correspond to the user's PM are listed in the user's profile. PM's may be designed mainly for the purpose of computing a PMS. Therefore, they may not be meaningful and describe parameters that serve no intuitive value (for example the parameters may be a result of a statistical processing method, such as subspace projected variables obtained using principal component analysis).

In contrast, PT's describe meaningful descriptors of the user's personality. Some examples of PT's are: “creative”, “goal-oriented”, and “calm”. Determining which PT's the user belongs to may be obtained in several different ways. First, PT's may be obtained by a personality test that results in a discrete classification of personality type (e.g., Myers Briggs Type Indicator—MBTI). Alternatively, PT's may be derived from the PM, for example, by applying statistical clustering techniques to PM's resulting in PM groups. PT's may also be obtained by user peer reporting, e.g., the way other users describe a user.

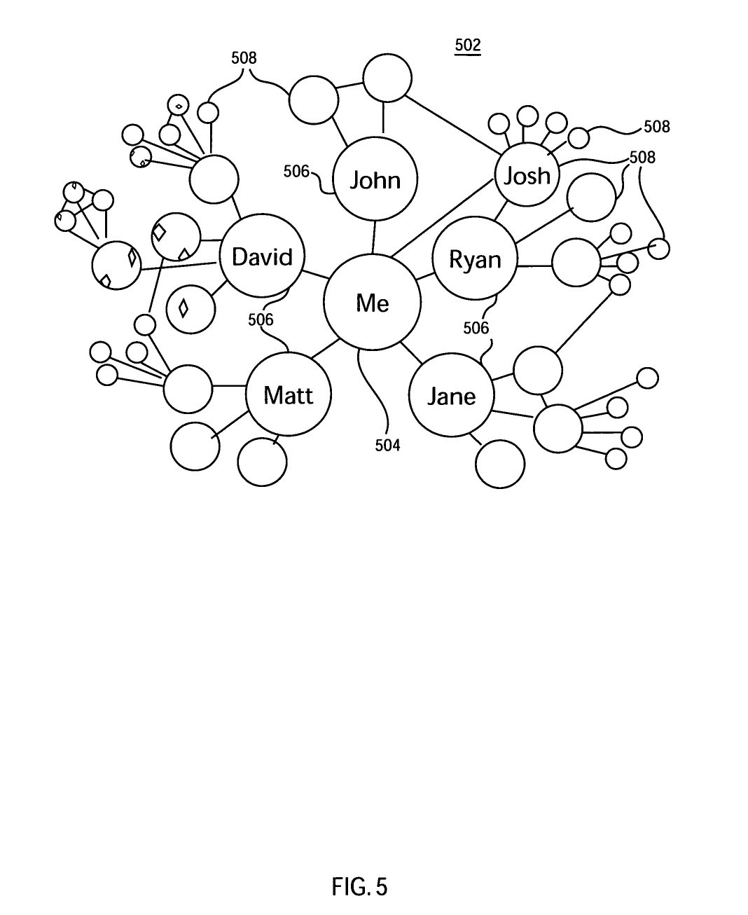

At least the following functions may be performed by a SC system in accordance with present principles: (1) Discovering new users based on PT or matching PM's using the PMS. (2) Assessing the PMS between two users that know each other. (3) Adapting and modifying the way users interact based on their personality and additional inputs (such as explicit preferences entered by users). For example, changing the color of a chat window, or the visual images that constitute the user interface. (4) visualizing the space of users based on PMS only or PMS in combination with other user closeness measures such as residence closeness, same employer, and same favorite artists. The visualization shows which users are closer (in their personality or in their personality combined with other closeness indications). The closeness may be indicated by any visual indication such as color-code or physical distance. In one embodiment, the visualization is composed of a graph where every node is a user and the arches/lines between nodes indicate closeness, as shown in FIG. 5.

(5) Browsing users using the user visualization. (6) Users receive content or content-recommendation based on their PM or PT's. In one embodiment, the content or content-recommendations are obtained by analyzing the statistical relationship between certain PT's or PM groups and certain content, e.g., recommending content that is more likely to be consumed by users of similar personality.

Referring again to FIG. 1, results are provided in block 108. The results may be provided in many forms. For example, the results may be provided in a list form or other textual format. In other embodiments, a visual or graphically results report in provided. FIG. 5 shows a particularly useful graphic visualization.

Referring to FIG. 5, a graphic visualization 502 shows which users are closer (in their personality or in their personality combined with other closeness indications) to a given user 504. In the example depicted, a user (Me) 504 is centrally located with closest matches 506 to its personality type disposed is the closest proximity to the representation of the user 504. A color, size or other visual indicator may provide information for the closest matches 506 and any matches 508. For example, the closeness may be indicated by any visual indication such as color-code or physical distance to indicate specific traits or dominant traits of closeness. Say, the dominant trait is closeness of residences; the color of the representation of John may be green to indicate that this was a dominant feature in the closeness match.

In one embodiment, the visualization is composed of a graph where every node is a user and the arches/lines between nodes indicate closeness, as shown in FIG. 5. Other features may include adding or eliminating criteria to re-render the visualization to fine tune search results. Other visualization graphs or techniques may also be employed.

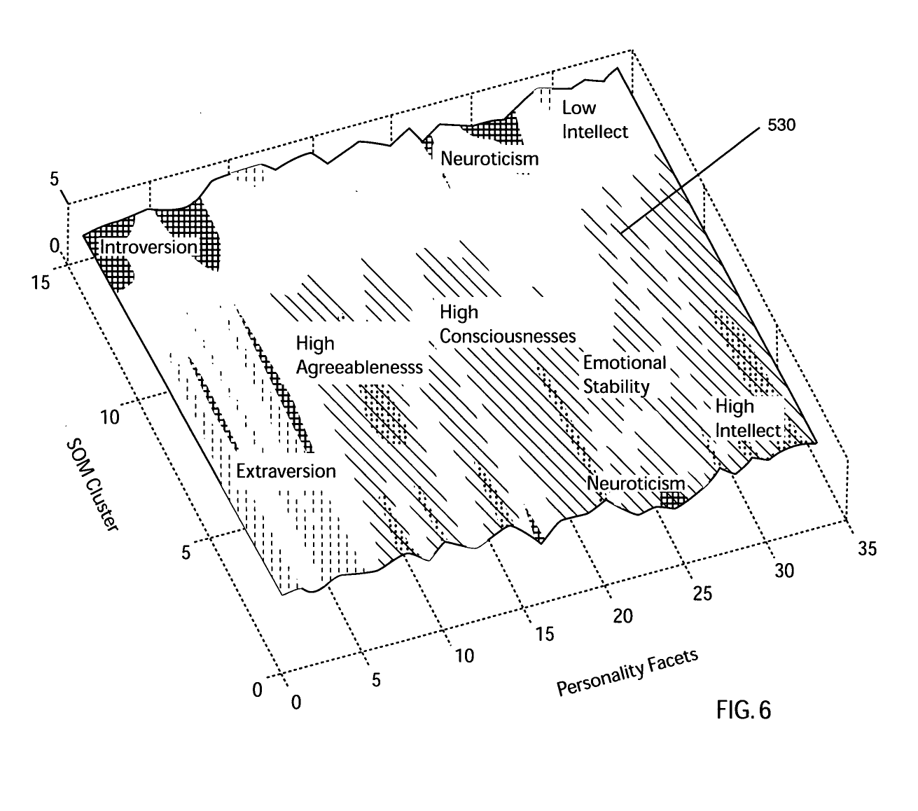

Referring to FIG. 6, a three-dimensional surface 530 shows personality facets or characteristics (x-axis) versus cluster or group identity criteria (self-organizing map (SOM) clustering on the y-axis). SOM clustering may include criteria employed in defining PTs. The intensity of each of the listed characteristics is depicted based on shading along the z-axis. The characteristics in this example include introversion/extraversion, agreeableness, consciousness, emotional stability/neuroticism and intellect. Other characteristic and clusters may be employed. A user may be able to map them and then select other users with similar characteristics or desirable characteristics to communicate with. The surface 530 was derived based on data from 157 subjects.

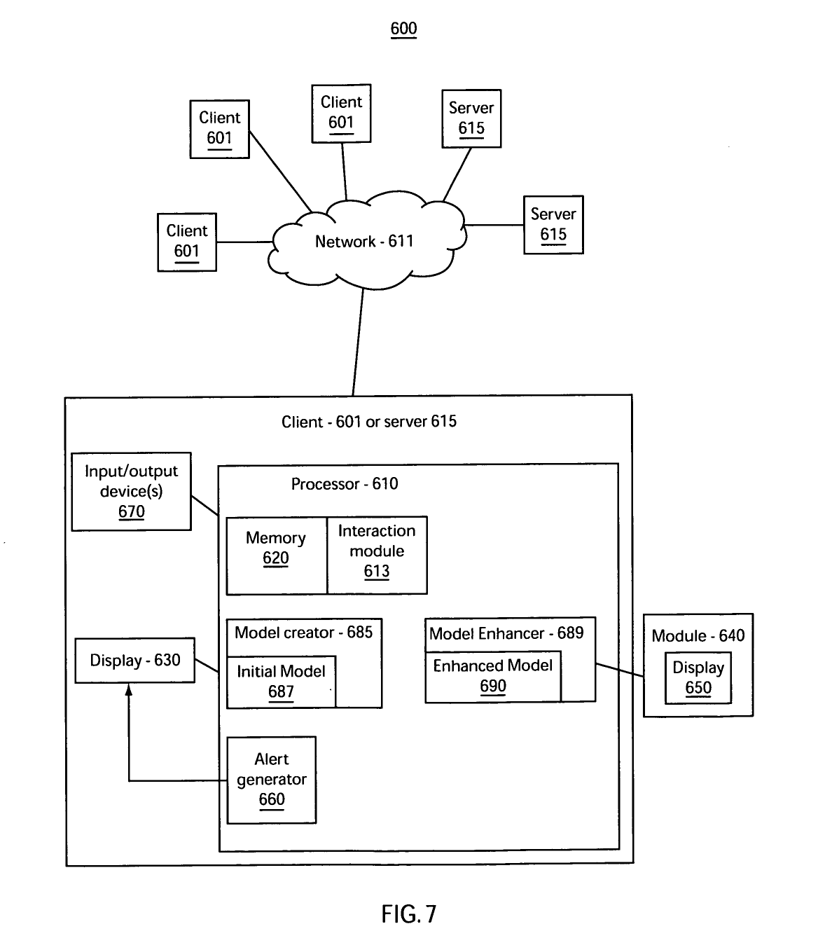

Referring to FIG. 7, a social computing system 600 is shown in accordance with an illustrative embodiment. The system 600 includes clients 601. Each client may be implemented on a single processor 610 or a plurality of processors distributed over a network 611. Processors 610 are each operationally coupled to a memory 620, a display 630, an input/output (I/O) device(s) 670, and to other modules or device 640, which may be implemented in hardware software or a combination thereof. Device 640 may include a handheld or portable device (PDA, telephone, computer, etc.) that connects to the system and includes display 650.

The memory 620 may be any type of device for storing application data as well as other data, such as personality profiles. The application data and other signals such as personality search and/or match requests, are received by the processor 610 for configuring the processor 610 to perform operations in accordance with the present system. Processors 610 may include or be employed as a server 615 to handle interactions between users. Server 615 may be employed to provide matching or interaction services, provide and update user profiles/user models, and otherwise provide services to users/clients 601. Clients 601 may be equipped to provide these services as well depending on software loaded thereon.

Processor 610 (or server 615) and memory 620 may include hardware and/or software that functions as an interaction module 613 capable providing system operations and services to a user or users.

The operations include controlling at least one of the display 630 or a display 650 to display a user interface (UI) that depicts a visual environment that may be larger than the respective displays 630, 650. The input/output 670 may include a keyboard, mouse, or other device, including touch sensitive displays, which may be stand alone or part of a system, such as part of a personal computer, personal digital assistant or cell phone, for communicating with the processor via any type of link, such as wired or wireless link(s).

An alert signal indicating a match or other alerts programmed by a user is produced by the processor 610 through an alert generator 660. The alert may include one or more of a tactile alert, an auditory alert, and visual alert. The alert generator 660 may work in conjunction with a PDA or cell phone and may be operationally coupled to the processor 610 and/or a display interface of a separate portable device (not shown). However, the alert generator 660 may simply be a module for generating a display icon on the display 630 or user interface display 650. Display 630 may include a liquid crystal display (LCD), a cathode ray tube (CRT), etc.

The module 640 (and/or processor display 630) may perform other operations including displaying television signals, a gaming environment, etc. Only a single display is needed for operation, although additional displays may also be utilized or other peripheral devices introduced into the system 600.

The methods of the present system 600 are particularly suited to be carried out by a computer software program, such computer software program preferably includes modules corresponding to the individual steps or acts of the methods. Such software can of course be embodied in a computer-readable medium, such as an integrated chip, a peripheral device or memory, such as the memory 620 or other memory coupled to the processor 610.

The computer-readable medium and/or memory 620 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, and/or a wireless channel using, for example, time-division multiple access, code-division multiple access, or other wireless communication systems). Any medium known or developed that can store information suitable for use with a computer system may be used as the computer-readable medium and/or memory 620.

Additional memories may also be employed. The computer-readable medium, the memory 620, and/or any other memories may be long-term, short-term, or a combination of long- and-short term memories. These memories configure processor 610 to implement the methods, operations, and functions disclosed herein. The memories may be distributed or local and the processor 610, where additional processors may be provided, may be distributed or singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 620, for instance, because the processor 610 may retrieve the information from the network.

The processor 610 and memory 620 may be any type of processor/controller and memory, such as those described in U.S. Application No. 2003/0057887, which is incorporated herein by reference. The processor 610 is capable of providing control signals and/or performing operations in response to input signals from the I/O device 670 and/or module 640, and executing instructions stored in the memory 620. The processor 610 may be an application-specific or general-use integrated circuit(s). Further, the processor 610 may be a dedicated processor for performing in accordance with the present system or may be a general-purpose processor wherein only one of many functions operates for performing in accordance with the present system. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems.

Individual users interact with a processor 610 or server 615 to access a model creator 685 configured to create an initial model 687 of a user. The initial model 687 may be created in a plurality of ways, for example, the initial model may be created based on a questionnaire of a user's personality, by recording and analyzing the user's interaction with other users in the social network, by creating the initial from or augmenting the initial model by direct input from other users. Further, the initial model may be created from or augmented by using a world personality model that describes a personality of a group of users.

The user can then interact with system features, which may include performing searches to find compatible or similar users, communicate with other users or otherwise interact with the system and/or other users. Concurrently and over time, the system 600 uses a model enhancement module 689 feature to analyze and record interactions of the user with other users in the social network to update and adjust the initial model 687 to provide an enhanced model 690 for the user. The enhanced model 690 may be enhanced based on a questionnaire of a user's personality, by recording and analyzing the user's interaction with other users in the social network, by updating the initial model by direct input from other users. The enhanced model may be created from or augmented by using a world personality model that describes a personality of a group of users.

An interaction module 613 provides user services and is configured to permit interaction between users by employing one of the initial model 687 and the enhanced model 690 of each user. For example, the interaction module 613 can calculate a personality match score between at least two models of users in the social network indicating closeness based on one or more criteria. The personality match score may be calculated for a specific predefined type of relationship. The interaction module 613 can group users by personality types, where a personality type is a descriptor of the user personality based on the personality test assessment methods. In addition, the interaction module 613 can group users by personality types, where a personality type is a descriptor of the user personality based on input from other users.

The interaction module 613 permits searches for users based on at least one of a personality match score of user models and a same personality type. Module 613 handles all browsing activities of the users.

In a particularly useful embodiment, the interaction module 613 adjusts a user interaction interface based on at least one of personality models, personality match scores, and personality types. E.g., colors, window size, textures, and functions may be adjusted based on the individual user's personality model, personality type or interactions with another user based on the match score. For instance, in a match score is high, during interaction between the highly matched pair different interface features are observed and provided for the highly matched pair.

The interaction module 613 may provide a visualization graph 502 or 530 (see FIGS. 5 and 6) based on closeness criteria between user models. The visualization graph may include other information known about users being displayed including at least one of predefined user information stored in memory or user profiles, supplied by the users, and derived and/or predicted from other sources relating to the users. The visualization graph is browsable by the user based on elements in the visualization graph.

In another feature, the interaction module 613 can sends content and/or recommendations for content to users based on one or more of personality models, personality types, and personality match scores. It should be understood that the model creator 687, the model enhancer 689, and interaction model 613 may be located on a server 615 and not accessible by clients 601. During interactions between clients 601, server 615 monitors activities and updates the user models accordingly. Server 615 may further permit user searches, etc. by storing the latest versions of all of the user personality models or profiles.

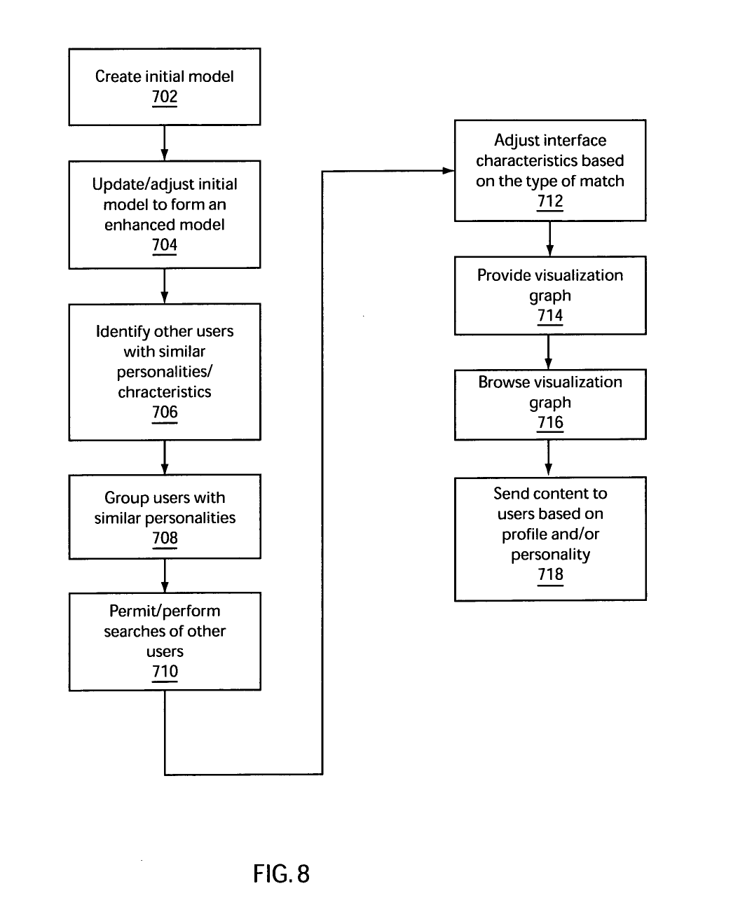

Referring to FIG. 8, another system/method for social computing is illustratively depicted. In block 702, creating an initial model of a user is performed. Creating the initial model may include creating the initial model based on a questionnaire of a user's personality, by recording and analyzing the user's interaction with other users in the social network, from direct input from other users, and/or employing a world personality model that describes a personality of a group of users to create or enhance the model.

In block 704, updating and adjusting the initial model to provide an enhanced model for the user by analyzing and recording interactions of the user with other users in a social network is performed. The enhanced model may be enhanced based on a questionnaire of a user's personality, by recording and analyzing the user's interaction with other users in the social network, from direct input from other users, by employing a world personality model that describes a personality of a group of users to create or enhance the model.

In block 706, identifying other users with similar characteristics/personalities based on one of an initial model and an enhanced model of the other users pursuant to an inquiry of the user is performed. This may include calculating a personality match score between at least two models of users in the social network indicating closeness based on one or more criteria. The personality match score may be computed for a specific predefined type of relationship.

In block 708, grouping users by personality types may be performed. A personality type is a descriptor of the user personality based on the personality test assessment methods, or a descriptor of the user personality based on input from other users. In block 710, searches for users are permitted based on at least one of a personality match score of user models and a same personality type. Searches or other interactions with the system or others users may be performed. The searches for other users with similar interests or personalities may be based on similarity scores, personality models, or other matching criteria.

In block 712, one of an appearance and functionality of a user interaction interface may be adjusted or set based on at least one of personality models, personality match scores, and personality types. In other words, the type of match, closeness (e.g., score difference) or other criteria between users may be adjusted during communications between the two users. If for example, the type of relationship is based on a romantic theme, the user interface would provide visual images or a general appearance related to this type of relationship. In addition, other facets of the interface may change based on the closeness in scores.

In block 714, a visualization graph based on closeness criteria between user models discovered during the inquiry may be generated. The visualization graph may include other information known about users being displayed including at least one of predefined user information stored in memory or user profiles, supplied by the users, and derived, predicted from other sources relating to the users, etc. The visualization graph may be browsed by the user, in block 716, to interact with the other users and/or discover information about the other users.

In block 718, content and/or recommendations for content may be sent out to users based on one or more of personality models, personality types, and personality match scores.

of course, it is to be appreciated that any one of the above embodiments or processes may be combined with one or with one or more other embodiments or processes to provide even further improvements in finding and matching users with particular personalities, and providing relevant recommendations.

The above description is intended to be merely illustrative of the present systems and methods and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A social computing system, comprising:
a model creator configured to create an initial model of a user;
a model enhancement module configured to analyze and record interactions of the user with other users in a social network to update and adjust the initial model to provide an enhanced model for the user; and
an interaction module configured to permit interaction between user by employing one of the initial model and the enhanced model.

2. The system as recited in claim 1, wherein the initial model is created based on a questionnaire of a user's personality.

3. The system as recited in claim 1, wherein the initial model is created by recording and analyzing the user's interaction with other users in the social network.

4. The system as recited in claim 1, wherein at least one of the initial model and the enhanced model are created from or augmented by direct input from other users.

5. The system as recited in claim 1, wherein at least one of the initial model and the enhanced model are created from or augmented by using a world personality model that describes a personality of a group of users.

6. The system as recited in claim 1, wherein the interaction module calculates a personality match score between at least two models of users in the social network indicating closeness based on one or more criteria.

7. The system as recited in claim 6, wherein the personality match score is calculated for a specific predefined type of relationship.

8. The system as recited in claim 1, wherein the interaction module groups users by personality types, where a personality type is a descriptor of the user personality based on the personality test assessment methods

9. The system as recited in claim 1, wherein the interaction module groups users by personality types, where a personality type is a descriptor of the user personality based on input from other users.

10. The system as recited in claim 1, wherein the interaction module permits searches for users based on at least one of a personality match score of user models and a same personality type.

11. The system as recited in claim 1, wherein the interaction module adjusts a user interaction interface based on at least one of personality models, personality match scores, and personality types.

12. The system as recited in claim 1, wherein the interaction module provides a visualization graph based on closeness criteria between user models.

13. The system as recited in claim 12, wherein the visualization graph includes other information known about users being displayed including at least one of predefined user information stored in memory or user profiles, supplied by the users, and derived and/or predicted from other sources relating to the users.

14. The system as recited in claim 12, wherein the visualization graph is browsable by the user based on elements in the visualization graph.

15. The system as recited in claim 1, wherein the interaction module sends one of content and recommendations for content to users based on one or more of personality models, personality types, and personality match scores.

16. A method for social computing, comprising:
creating an initial model of a user;
updating and adjusting the initial model to provide an enhanced model for the user by analyzing and recording interactions of the user with other users in a social network; and
identifying other users with similar characteristics based on one of an initial model and an enhanced model of the other users pursuant to an inquiry of the user.

17. The method as recited in claim 16, wherein creating includes creating the initial model based on a questionnaire of a user's personality.

18. The method as recited in claim 16, wherein creating includes creating the initial model by recording and analyzing the user's interaction with other users in the social network.

19. The method as recited in claim 16, wherein creating includes creating the initial model from direct input from other users.

20. The method as recited in claim 16, wherein updating and adjusting includes updating and adjusting the enhanced model from direct input from other users.

21. The method as recited in claim 16, wherein for at least one of the initial model and the enhanced model, employing a world personality model that describes a personality of a group of users to create or enhance a model.

22. The method as recited in claim 16, wherein identifying includes calculating a personality match score between at least two models of users in the social network indicating closeness based on one or more criteria.

23. The method as recited in claim 22, wherein the personality match score is calculated for a specific predefined type of relationship.

24. The method as recited in claim 16, further comprising grouping users by personality types, where a personality type is a descriptor of the user personality based on the personality test assessment methods.

25. The method as recited in claim 24, wherein grouping includes grouping users by personality types, where a personality type is a descriptor of the user personality based on input from other users.

26. The method as recited in claim 16, further comprising permitting searches for users based on at least one of a personality match score of user models and a same personality type.

27. The method as recited in claim 16, further comprising adjusting one of an appearance and functionally of a user interaction interface based on at least one of personality models, personality match scores, and personality types.

28. The method as recited in claim 16, further comprising generating a visualization graph based on closeness criteria between user models discovered during the inquiry.

29. The method as recited in claim 28, wherein the visualization graph includes other information known about users being displayed including at least one of predefined user information stored in memory or user profiles, supplied by the users, and derived and/or predicted from other sources relating to the users.

30. The method as recited in claim 28, further comprising browsing the visualization graph to one of interact with the other users and discover information about the other users.

31. The method as recited in claim 16, further comprising sending one of content and recommendations for content to users based on one or more of personality models, personality types, and personality match scores.

32. A computer program product for social computing comprising a computer useable medium including a computer readable program, wherein the computer readable program when executed on a computer causes the computer to perform the steps of claim 16.

33. A social computing system, comprising:
a model creator configured to create an initial model of a user;
a model enhancement module configured to analyze and record interactions of the user with other users in a social network to update and adjust the initial model to provide an enhanced model for the user;
an interaction module configured to permit searches by the user to search one of an initial model and an enhanced model of other users wherein the interaction module calculates a personality match score between models of users in the social network indicating closeness based on one or more criteria; and
a visualization graph generated by the interaction module based on closeness criteria between the user models.

34. The system as recited in claim 33, wherein the visualization graph displays relative closeness based on visual representations of other user information.

35. The system as recited in claim 33, wherein the visualization graph is browsable by the user based on elements in the visualization graph.
